(19) United States
(12) Patent Application Publication
(10) Pub. No.: US 2015/0310168 A1
(43) Pub. Date: Oct. 29, 2015

(54) METHOD FOR PREDICTING GENE CLUSTER INCLUDING SECONDARY METABOLISM-RELATED GENES, PREDICTION PROGRAM, AND PREDICTION DEVICE

(71) Applicant: NATIONAL INSTITUTE OF ADVANCED INDUSTRIAL SCIENCE AND TECHNOLGOY, Chiyoda-ku, Tokyo (JP)

(72) Inventors: Masayuki MACHIDA, Sapporo-shi, Hokkaido (JP); Maiko UMEMURA, Sapporo-shi, Hokkaido (JP); Hideaki KOIKE, Tsukuba-shi, Ibaraki (JP); Itaru TAKEDA, Tsukuba-shi, Ibaraki (JP)

(21) Appl. No.: 14/427,349

(22) PCT Filed: Sep. 24, 2013
(86) PCT No.: PCT/JP2013/075702

§ 371 Date: Jun. 15, 2015

(30) Foreign Application Priority Data
Sep. 24, 2012 (JP) 2012-210044

(51) Int. Cl. G06F 19/24; G06F 19/14

(52) U.S. Cl. CPC G06F 19/24; G06F 19/14

(57) ABSTRACT

This invention provides a method for predicting a gene cluster including secondary metabolism-related genes with high accuracy, independent of information concerning core genes. Such method comprises: a step of identifying a region the gene arrangement of which is conserved in nucleotide sequence information of another genome as a gene cluster on the basis of the results of homology search conducted with the use of nucleotide sequence information of at least a pair of genomes; and a step of determining whether or not the gene cluster of interest includes secondary metabolism-related gems on the basis of the proportion of synteny-like regions within the gene cluster identified by the above step.

### TECHNICAL FIELD

The present invention relates to a method for predicting a gem cluster including secondary metabolism-related genes from among gene clusters composed of a plurality of genes, a prediction program, and a prediction device.

### BACKGROUND ART

Secondary metabolites have a high likelihood of being biologically active, and they are very useful as lead compounds for pharmaceuticals. There are a wide variety of secondary metabolites, and they are found in various organism species, such as actinomycetes, fungi, and plants. However, such secondary metabolites are pressed only under special conditions that may not be revealed yet, and there is much that remains unknown about such secondary metabolites. This, it is believed that many secondary metabolites having useful properties remain undiscovered. Even if such secondary metabolites were to be discovered, it would be difficult to stably produce sufficient amounts thereof. Accordingly, problems arise when the use of such secondary metabolites is intended.

Along with innovative progress in DNA sequencing techniques in recent years, genomic information of various organism species (microorganism, in particular) is accumulating at an accelerated rate. Accordingly, it is certain that genomic nucleotide sequences of several thousand or more types of microorganisms will be determined within a period of several years. Organisms whose genomic information remains unknown may be subjected to the aforementioned DNA sequencing techniques, so that genomic information thereof can be acquired rapidly in a cost-effective manner. Because of the accumulation of genomic information and convenience of genomic information analysis, comparative genomic analysis, such as whole-gnome analysis and synteny analysis, becomes applicable to a wide variety of organism species.

With the use of databases constructed by accumulating detailed and vast amounts of genome information and information concerning the structures of secondary metabolites, diversity thereof or the distribution thereof in living world, accordingly, discovery of useful unknown secondary metabolites and identification of genes involved in biosynthesis of secondary metabolites (i.e., secondary metabolism-related genes) can be expected. However, it has been difficult to identify the secondary metabolism-related genes with high accuracy with the use of currently available comparative genome analysis techniques for the following reasons. That is, secondary metabolism-related genes are often contradictory to phylogenetic trees of genera and species, and the are numerous unknown genes whose functions remain unknown.

In the past, secondary metabolism-related genes had been analyzed on the basis of detection of known genes with high sequence homology (i.e., core genes), such as polyketide synthase (PKS) genes or nonribosomal peptide synthetase (NRPS) genes, and prediction of a cluster including genes associated therewith. Specific examples include SMURF described “in Khaldi Nora; Seifuddin Fayaz T.; Turner Geoff; et al., SMURF: Genomic mapping of fungal secondary metabolite clusters, FUNGAL GENETICS AND BIOLOGY, 47, 9, 73741, 2010”, antiSMASH described in “Medema Marnix H.; Blin Kai; Cimermancic Peter et al., antiSMASH: rapid identification, annotation and analysis of secondary metabolite biosynthesis gene clusters in bacterial and fungal genome sequences, NUCLEIC ACIDS RESEARCH, 39, 339-346, 2011”, CLUSEAN described in “Weber T.; Rausch C.; Lopez P.; et al., CLUSEAN: A computer-based framework for the automated analysis of bacterial secondary metabolite biosynthetic gene clusters, JOURNAL OF BIOTECHNOLOGY, 140, 1-2, 13-17, 2009”, and ClustScan described in “Starcevic Antonio; Zucko Jurica; Simunkovic Jurica; et al., ClustScan: An integrated program package for the semi-automatic annotation of modular biosynthetic gene clusters and in silico prediction of novel chemical structures, NUCLEIC ACIDS RESEARCH, 36, 21, 6882-6892, 2008”.

However, clusters detected by such techniques are limited to secondary metabolic gene clusters including core genes, which are parts of whole clusters including secondary metabolism-related genes. In other words, it was impossible according to the aforementioned techniques to predict secondary metabolic gene clusters that do not include core genes possibly accounting for a half or more of whale clusters.

### SUMMARY OF THE INVENTION

### Objects to be Attained by the Invention

Under the above circumstances, objects of the present invention are to provide a method that can predict a gene cluster including secondary metabolism-related genes with high accuracy, independent of the information concerning car genes, a prediction program, and a prediction device.

### Means for Attaining the Objects

The present invention, which has attained the objects described above, includes the following.

(1) A method for predicting a gene cluster including secondary metabolism-related genes comprising:

a step of subjecting genes included in nucleotide sequence information of at least a pair of genomes to homology search mutually to identify homologous gene combinations in the nucleotide sequence information of the genomes and orthologous gene combinations in the homologous gene combinations;

a step of identifying a region of the gene arrangement of which is conserved in the nucleotide sequence information of the other genomes as a gene cluster on the basis of the results of homology search; and

a step of identifying a synteny-like region in the gene cluster identified in the previous step on the basis of the presence of orthologous genes determined as a result of homology search and evaluating whether or not the gene cluster includes secondary metabolism-related genes on the basis of the rate of the synteny-like region in the gene cluster.

(2) The method of prediction according to (1), wherein the gene cluster is evaluated to include secondary metabolism-related genes when the rats of the genes included in the synteny-like region relative to the genes included in the whole go cluster is not more than a given level.
(3) The method of prediction according to (2), wherein the given level is 25%.
(4) The method of prediction according to (1), wherein the synteny-like region includes at least two orthologous genes and the distance between neighboring orthologous genes is within a given distance in the nucleotide sequence information of genomes and in the nucleotide sequence information of the other genomes.
(5) The method of prediction according to (4), wherein the given distance is 10 kb to 30 kb.
(6) The method of prediction according to (1), wherein a synteny region and a non-synteny region are determined in advance using nucleotide sequence information of one of at least a pair of genomes subjected to comparison and nucleotide sequence information of a third genome that is different from the pair of genomes and the determined synteny region is designated as a synteny-like region.
(7) The method of prediction according to (1), wherein the step of gene cluster identification is followed by a step in which the number of homologous genes included in the identified gene cluster and/or the total number of genes included in the identified gene cluster are compared with the predetermined standard values and the step of evaluating whether or not the gene cluster includes secondary metabolism-related genes is carried out with regard to the gene cluster exhibiting the number of homologous genes not less than the standard value and/or the gene cluster exhibiting the total number of genes less than the standard value.
(8) The method of prediction according to (7), wherein the standard value for the number of homologous genes is designated 3 and the standard value for the total number of genes is designated 35.
(9) The method of prediction according to (1), wherein the step of gene cluster identification is followed by a step in which the total number of genes included in the identified gene cluster is compared with the predetermined standard value or a length of the identified gene cluster is compared with the predetermined standard value and the step of evaluating whether or not the gene cluster includes secondary metabolism-related genes is carried out with regard to the gene cluster exhibiting the total number of genes or the length less than the standard value,

wherein, in the step of evaluating whether or not the gene cluster includes secondary metabolism-related genes, genes neighboring the gene duster to be evaluated are added to modify the gene cluster to comprise the number of genes defined a the standard value and a synteny-like region in the modified gene cluster consisting of the number of genes defined as the standard value is identified.

(10) The method of prediction according to (9), wherein the standard value for the total number of genes is designated 35.
(11) The method of prediction according to (1), wherein the step of gene cluster identification is followed by a step in which the total number of genes included in the identified gene cluster is compared with the predetermined standard value or a length of the identified gene cluster is compared with the predetermined standard value and the step of evaluating whether or not the gene cluster includes secondary metabolism-related genes is carried out with regard to the gene cluster exhibiting the total number of genes or the length less than the standard value,

wherein, in the step of evaluating whether or not the gene cluster includes secondary metabolism-related genes, a given number of genes or a given length of a region is added to modify the gene cluster to be evaluated and a synteny-like region in the modified gene cluster is identified.

(12) The method of prediction according to (1), wherein the step of gene cluster identification comprises starting the trace backing from a cell exhibiting the maximal score in the Smith-Waterman matrix built on the basis of the Smith-Waterman algorithm so as to identify a gene cluster.
(13) The method of prediction according to (12), wherein the step of gene cluster identification comprises assigning a score of 0 into a cell included in the identified gene cluster, subjecting the Smith-Waterman matrix to the trace backing so as to identify another region in which the gene arrangement is conserved, subjecting the identified region to the Smith-Waterman algorithm again so as to identify a region the gene arrangement of which is conserved, and identifying the region as a gene cluster.
(14) The method of prediction according to (1), wherein the step of gene cluster identification is followed by a step in which the total number of genes included in the identified gene cluster is compared with the predetermined standard value or a length of the identified gene cluster is compared with the predetermined standard value and a given number of genes or a given length of a region of is added to the gene cluster so as to elongate the gene cluster to the standard size,

positive scores are given to the genes constituting the elongated gene cluster that are homologous to the genes constituting the gene cluster in the nucleotide sequence information of the other genomes to be compared, and negative scores are given to the genes that are not homologous,

scores are successively totaled from the gene located at the center of the gene cluster toward the ends and the genes exhibiting the maximal total scores are identified as the gene cluster boundaries, and

a region between the genes identified as the boundaries is identified a gene cluster.

(15) The method of prediction according to (14), wherein the predetermined standard value for the total number of genes is designated 15 to 65.

This description includes part or all of the content as disclosed in the description and/or drawings of Japanese Patent Application No. 2012-210044, which is a priority document of the present application.

### Effects of the Invention

The present invention enables prediction of a novel cluster including secondary-metabolism-related genes, regardless of the presence or absence of core genes, by application of a technique of nucleotide sequence comparison to an arrangement of genes recognized as a sequence via a comparative genomics method and by distinguishing a region of interest from a simple synteny.

### BRIEF DESCRIPTION OF THE DRAWINGS

FIG. 1 shows a flow diagram concerning a method for predicting a gene cluster including secondary metabolism-related genes according to the present invention.

FIG. 2 shows a concept of the matrix built in accordance with the Smith-Waterman algorithm when identifying a gene cluster through the prediction method of the present invention.

FIG. 3 shows a flow diagram for the prediction method of the present invention comprising steps of identifying a gene duster, subjecting the identified gone cluster to orthologue verification, and identifying a gene cluster including secondary metabolism-related genes at the end.

FIG. 4 schematically illustrates a process of orthologue verification via the prediction method of the present invention.

FIG. 5 schematically illustrates a process of orthologue verification via the prediction method of the present invention.

FIG. 6 schematically illustrates a process of orthologue verification via the prediction method of the present invention.

FIG. 7 schematically illustrates a process of modifying the gene cluster boundary in the prediction method of the present invention.

### EMBODIMENTS FOR CARRYING OUT THE INVENTION

Hereafter, the present invention is described in detail with reference to the drawings.

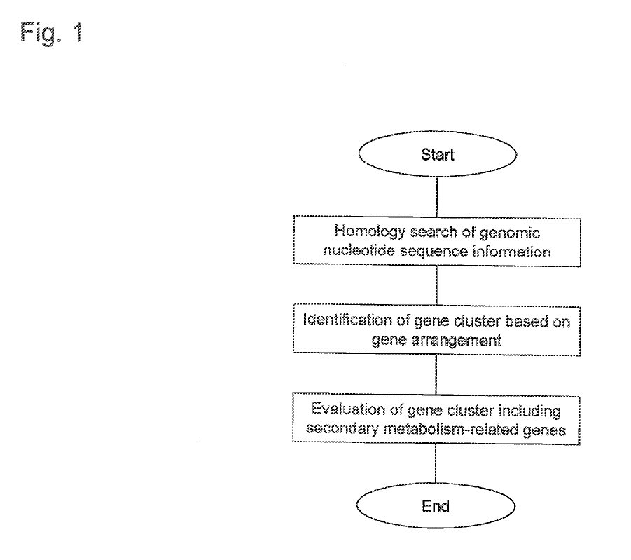

The method for predicting a gene cluster including secondary metabolism-related genes according to the present invention comprises: a step of using the results of homology search conducted on genes included in at least a pair of genomes to identify a gene cluster on the basis of the arrangement of the compared genomic genes; and a step of determining whether or not the identified gene cluster includes secondary metabolism-related genes (FIG. 1).

The term “secondary metabolism-related genes” used herein refers to genes involved in biosynthesis of secondary metabolites. The term “secondary metabolites” refers to metabolites that are not directly associated with vital activity of organisms. When substances synthesized by organisms are collectively referred to as “metabolites,” metabolites are classified as primary metabolites or secondary metabolites. In such a case, secondary metabolites can be metabolites other than primary metabolites. The term “primary metabolites” refers to substances that are directly associated with vital activity of organisms. Examples thereof include sugars, amino acids, lipids, and nucleic acids. That is, “secondary metabolites” may be defined as substances other than sugars, amino acids, lipids, and nucleic acids. Examples of secondary metabolites include antibiotics, alkaloid, terpenoid, flavonoid, polyketide, phenols, glycoside, and special amino acids that do not constitute a protein.

Genes involved in biosynthesis of secondary metabolites encompass genes encoding enzymes associated with assimilation reactions or dissimilation reactions of secondary metabolites, genes encoding proteins associated with translocation and/or accumulation of secondary metabolites, and genes encoding proteins associated with regulation of expression of such genes.

More specific examples of secondary metabolism-related genes include genes involved in biosynthesis of polyketide, nonribosomal peptide alkaloid, terpenoid, flavonoid, and other compounds that are not classified as primary metabolites. It should be noted that gene clusters predicted by the prediction method according to the present invention do not always include the secondary metabolism-related genes specifically exemplified above and that such gene clusters occasionally include other secondary metabolism-related genes.

### [Identification of Gene Cluster]

According to the method of the present invention, a gene cluster is first identified. The term “gene cluster” used herein refers to a group of a plurality of genes included in a given continuous region; and to a group of a plurality of genes whose arrangements are conserved among a plurality of genomes (e.g., between a pair of genomes). The term “continuous region” may be a region included in the entire genome or a part of the genome constituted by nucleic acids, such as chromosomes and mitochondria. Specifically, the term “gene cluster” refers to a group of a plurality of genes whose arrangements are conserved in a continuous region constituting the entire genome or a part of the genome.

Nucleotide sequence information of at least a pair of genomes is prepared in order to identify a gene cluster. Nucleotide sequence information of genomes is character data representing four types of nucleotides (i.e., adenine, guanine, cytosine, and thymine as A, G, C, and G, respectively). Nucleotide sequence information of genomes is represented starting from the 5′-end toward the 3′-end. Nucleotide sequence information of either or both of a pair of genomes may be obtained from a database storing nucleotide sequence information of various genomes, or such information may be obtained from a known or unknown organism via a DNA sequencing technique. Any of the DNA sequencing techniques described in, for example, Chapter 11 of Molecular Cloning A Laboratory Manual, Fourth Edition (Cold Spring Harbor Laboratory Press) can be employed.

Nucleotide sequence information of genomes may be obtained from any organism species. In other words, the prediction method of the present invention enables prediction of a gene cluster including secondary metabolism-related genes, regardless of organism species. Specific examples of organism species include plants, bacteria, actinomycetes, fungi, filamentous, fungi, and mushrooms. In addition, nucleotide sequence. Information of genomes may be derived from an unknown organism species. For example, the nucleotide sequence of DNA that is attracted directly from the environment such as from soil, sludge, lake water, or seawater, without culture (that is, so-called environmental DNA) may be determined, and the determined nucleotide sequence may be used as nucleotide sequence information of genome. According to the prediction method of the present invention, specially, a gene cluster including secondary metabolism-related genes existing in environmental DNA can be predicted.

In order to identify gene clusters based on nucleotide sequence information of at least a pair of genomes, at the outset, arrangements of a plurality of genes in the pair of genomes are compared on the basis of nucleotide sequence information of the genomes, and regions in which the gene arrangements are conserved are identified.

In order to compare the arrangements of genes, genes included in the nucleotide sequence information of the target pair of genomes are subjected to homology search mutually, and comminations of homologous genes between the nucleotide sequences information of the genomes and combinations of orthologous genes among the combinations of homologous genes are identified. To this end, the amino acid sequences encoded by a plurality of genes included in the nucleotide sequence information of the target pair of genomes are first deduced. The amino acid sequences can be deduced with the use of software for open reading frame analysis. With the use of such software for analysis, three open reading frames (ORFs) of the nucleotide sequence information of genomes represented starting from the 5′ end toward the 3′ end and complementary strands thereof can be identified. In this case, genes in nucleotide sequence information of one gnome are designated as xᵢ (i=1, 2, . . . , I), and genes in nucleotide sequence information of the other genome are designated as yⱼ (j=1, 2, . . . , J).

Subsequently, amino acid sequences of all genes included in nucleotide sequence information of one of the genomes are designated as query sequences, and homology search is carried out using the amino acid sequences of genes included in nucleotide sequence information of the other genome as database sequences. Homology search can be carried out with the use of conventional software for homology analysis, such as Blastp, FASTA, or Clustal. Also, the quay sequences are replaced with the database sequences, and homology search is carried out in the same manner as described above.

According to homology search, genes exhibiting high sequence similarity can be identified mutually in the nucleotide sequence information of the pair of genomes. For example, a threshold is determined for a value exhibiting sequence similarity, and a combination of genes exhibiting a value exceeding such threshold can be identified as homologous genes. Among the combinations of genes identified as homologous genes, the combinations of genes satisfying a given standard can be identified as orthologous genes. “Orthologous genes” are defined as homologous genes diverged from a common ancestral gene by speciation.

Examples of values exhibiting sequence similarity include e-values, bits, and amino acid identities determined by Blast search. By designating a threshold for one or more such values, accordingly, combinations of homologous genes can be identified. More specifically, the e-value as a threshold can be set at, for example, 1.0e-20, preferably 1.0e-15, and particularly preferably 1.0e-10, in homology search between query sequences and database sequences and in homology search conducted with the use of the query sequences and the database sequence in reverse (Such homology searches are collectively referred to as “a set of homology searches.”). A combination of genes exhibiting an e-value at or below the threshold as a result of the set of homology searches can be identified as homologous genes from among the nucleotide sequence information of the both genomes.

In order to identify orthologous genes from among the homologous genes identified in the manner described above, a standard is set so that a combination of genes satisfying the definition of orthologous genes described above can be selected. When a combination of genes is found to be in the top 5, preferably in the top 3, and particularly preferably at the top of the list of a set of gems prepared in descending order of sequence similarity (e.g., the ascending order of the e-value) as a result of the set of homology searches, specifically, such combination of genes can be defined as a combination of orthologous genes. From among the combinations of homologous genes identified as a result of the set of homology searches, a combination of orthologous genes can be identified by a method other than the method described above.

Subsequently, arrangements of genes in nucleotide sequence information of a pair of genomes are compared based an the results of homology search, and regions in which the gene arrangements are conserved are identified. In order to “compare the arrangements of genes in nucleotide sequence information of a pair of genomes,” assuming that a plurality of genes in the nucleotide sequence information of genomes constitute a string of letters in which genes are regarded as letters, an algorithm that searches for strings of letters and compares similarities thereof can be employed.

Examples of algorithms that can be used in this process include the Smith-Waterman algorithm, the Needleman-Wunsch algorithm, and the k-tuple method for searching strings of letters. The Smith-Waterman algorithm is particularly preferable because it enables a local alignment search to be carried out with high sensitivity.

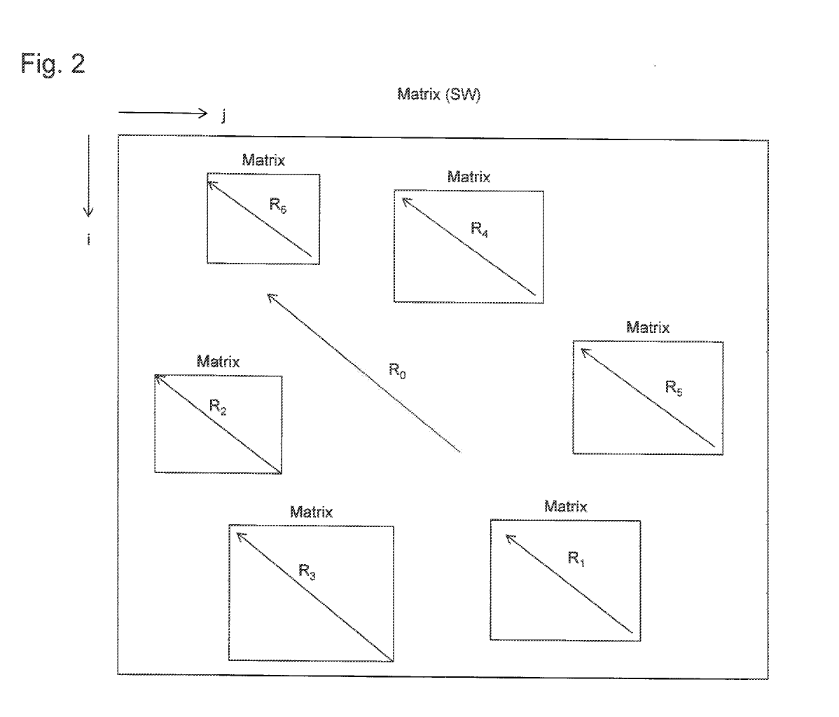

By employing the Smith-Waterman algorithm, specifically, arrangements of genes in nucleotide sequence information of a pair of genomes can be compared in the manner described below. Genes in the nucleotide sequence information of one of the genomes are designated as xᵢ (i=1, 2, . . . , I), and genes in the nucleotide sequence information of the other genome are designated as yⱼ (j=1, 2, . . . , J). According to the Smith-Waterman algorithm, the (J+1)×(I+1) matrix (two-dimensional) of the genes in the nucleotide sequence information of one of the genomes, xᵢ (i=1, 2, . . . , I), and that of the genes in the nucleotide sequence information of the other genome yⱼ (j=1, 2, . . . , J), are built (FIG. 2).

The scores determined in accordance with the procedures shown below are recorded in the cells of the matrix. When homology is observed between xᵢ and yⱼ, specifically, the score is determined in accordance with the formula indicated below.

$$SW ( j , i ) = max \{ \begin{matrix}SW ( j - 1 , i - 1 ) + 1 \\ SW ( j , i - 1 ) + gap \\ SW ( j - 1 , i ) + gap \\ 0\end{matrix} \}$$

When no homology is observed, the score is determined in accordance with the formula indicated below.

$$SW ( j , i ) = max \{ \begin{matrix}SW ( j - 1 , i - 1 ) + missmatch \\ SW ( j , i - 1 ) + gap \\ SW ( j - 1 , i ) + gap \\ 0\end{matrix} \}$$

When all the cells of the matrix are subjected to the scoring described above, the trace backing starts from the cell exhibiting the maximal score toward the cell exhibiting a score of 0. In the cells along the trace backing path, a set of coordinates exhibiting high homology between xᵢ and yⱼ is designated as R₀. Gap and mismatch scores are penalty scores, and they are set within the range from approximately −0.4 to −0.1, and both the gap and mismatch scores are preferably −0.2.

R₀={(j₁,i₁),(j₂,i₂), . . . (jₙ,iₙ)},

provided that

j₁≦j₂≦ . . . ≧jₙ,i₁≦i₂≦ . . . ≦iₙ

R₀ is a set of coordinates indicating the pair of highly homologous genes which are located in a region in which gene arrangement is conserved. Specifically, R₀ constitutes a gene cluster; that is, a group of a plurality of genes whose arrangements are conserved in the nucleotide sequence information of a pair of genomes. When a plurality of cells exhibit the maximal score in accordance with the matrix: (J+1)×(I+1), a plurality of gene clusters are identified through the process described above.

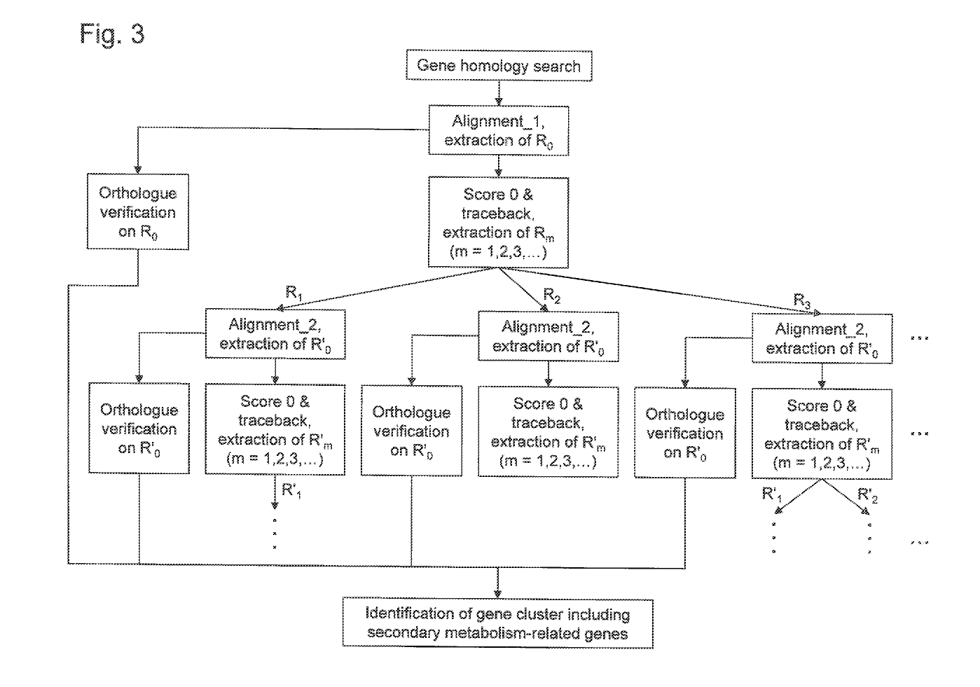

According to the prediction method of the present invention, whether or not the gene cluster R₀ identified in the manner described above includes secondary metabolism-related genes can be determined in the manner described below in detail. According to the prediction method of the present invention, in addition to the gene cluster R₀ identified in the manner described above, another gene cluster R′₀ can be identified, and whether or not such gene cluster R′₀ includes secondary metabolism-related genes can be determined in accordance with the procedures described below (FIG. 3).

A gene cluster R′₀ is a gene cluster other than the gone cluster R₀ described above, and it is identified by subjecting the gene clusters Rₘ (m=1, 2, 3, . . . ) each identified as a region in which the gene arrangement is conserved in relation to xᵢ (i=1, 2, . . . , I) and yⱼ (j=1, 2, . . . , J) to alignment analysis again (denoted as “Alignment 2” in FIG. 3).

A gene cluster including secondary metabolism-related genes is constituted by a wide variety of genes. When a gene cluster is compared with another gene cluster, accordingly, a large gap can appear as a result of insertion or deletion of a gene unit. In order to realize detection of a region containing many gaps as a gene cluster, a gene cluster Rₘ (m=1, 2, 3, . . . ) is identified with the use of the (J+1)×(I+1) matrix and acres obtained by the calculation described above. A method for identifying the gene cluster Rₘ (m=1, 2, 3, . . . ) is not particularly limited, and the process described below can be employed.

At the outset, “0” is assigned for all the cells indicated by the coordinates included in the set obtained in the previous step (starting from R₀).

SW(j,i)=0

provided that

(j,i)=(j₁,i₁),(j₂,i₂), . . . (jₙ,iₙ)

In the (J+1)×(I+1) matrix in which “0” is assigned for each cell of Re, subsequently, the trace backing starts again from the cell exhibiting the maximal score larger than 1 toward the cell exhibiting a score of 0. The cell exhibiting the maximal score larger than 1 satisfies the following condition, which is designated as “Condition *1.”

$$\{ \begin{matrix}Homoloby between {x}_{i} and {y}_{j} \\ SW ( j , i ) > 1 \\ max \{ SW ( j , i ) \}\end{matrix} \qquad {}^{*} 1$$

By starting the trace backing from the cell satisfying Condition *1 toward the cell exhibiting a score of 0, a set of coordinates indicating a cell in which high homology between xᵢ and yⱼ is exhibited can be identified (Rₘ). When a plurality of cells satisfy Condition in accordance with the matrix: (J+1)×(I+1) in which “0” is assigned for each cell of R₀, a plurality of gene clusters Rₘ (m=1, 2, 3, . . . ) are identified through the process described above.

If a plurality of gene clusters (m=1, 2, 3, . . . ) identified in the manner described above are sufficiently near the gene cluster R₀ that had already been identified, the score would be influenced of the scores of the cells included in the cluster R₀. In order to eliminate the influence by the scores of the cells included in the cluster R₀, after a plurality of gene clusters Rₘ (m=1, 2, 3, . . . ) have been identified in the manner described above, accordingly, it is preferable for the identified gene clusters Rₘ to be subjected to an algorithm for searching strings of letters, such as the Smith-Waterman algorithm, to re-identify the arrangement of conserved genes.

Concerning those satisfying n(Rₘ)≧3 in the set of Rₘ (m=1, 2, 3, . . . ), more specifically, a region satisfying the following condition is extracted.

(j₁≦j≦jₙ)∩(i₁≦i≦iₙ)

The scores are determined again while building the matrix (two-dimensional) in the manner as described above. Thus, a newly constructed gene cluster R′₀ can be derived from the gene cluster Rₘ (m=1, 2, 3, . . . ) identified in the manner described above.

By repeating the above procedure until the trace backing from the cell satisfying Conditions *1 toward the cell exhibiting a score of 0 can be no longer performed, gene clusters (R₀, R′₀, R″₀ . . . ) to be subjected to evaluation as to whether or not such gene clusters include secondary metabolism-related genes can be identified.

### [Evaluation of Gene Cluster Including Secondary Metabolism-Related Genes]

It is determined whether or not the gene cluster represented by R₀ or the gene clusters represented by R₀, R′₀, R″₀ . . . identified in the manner described above include secondary metabolism-related genes (“Orthologue verification” in FIG. 3).

According to the prediction method of the present invention, whether or not the gene cluster of interest includes secondary metabolism-related gene is determined by taking characteristic features, such as the facts that secondary metabolism-related genes are highly diversified and there me substantially no orthologous genes between different species, into consideration. Such characteristic features indicate that the proportion of synteny-like regions is small in a gene cluster including secondary metabolism-related genes. Accordingly, synteny-like regions in the identified gene clusters are identified, and whether or not the gene clusters of interest include secondary metabolism-related genes can be determined on the basis of the proportion of the synteny-like regions in the gene clusters.

More specifically, a synteny-like region in an identified gene cluster can be evaluated using the number of orthologous genes included in the gene cluster and the distance between such orthologous genes. In such a case, it is preferable that the scope of gene clusters to be evaluated be limited on the basis of gene cluster size or the number of homologous genes included in such gene clusters. Specifically, whether or not the gene cluster represented by R₀ or the gene clusters represented by R₀, R′₀, R″₀ . . . include(s), for example, 2 or more, and preferably 3 or more combinations of homologous genes is inspected. Also, whether or not the total number of genes is, for example, 50 or less, preferably 40 or less, and more preferably 35 or less is inspected. The gene clusters satisfying both conditions described above are preferably subjected to orthologue verification in order to identify synteny-like regions. A gene cluster that does not satisfy either condition is not subjected to the subsequent procedure, and it is rejected as a gene cluster that does not include secondary metabolism-related genes. When a standard such that the number of homologous gene combinations is 3 and the total number of genes is 35 is designated at this stage, for example, the scope of gene cluster is narrowed down under the conditions below (*2):

$$\{ \begin{matrix}3 \leq n ( {R}_{0} ) \\ {i}_{n} - {i}_{1} + 1 \leq 35 \\ {i}_{n} - {j}_{1} + 1 \leq 35\end{matrix} \qquad {}^{*} 2$$

wherein n represents a position of a gene in a gene cluster; and iₙ represents a position of a gene in the genome.

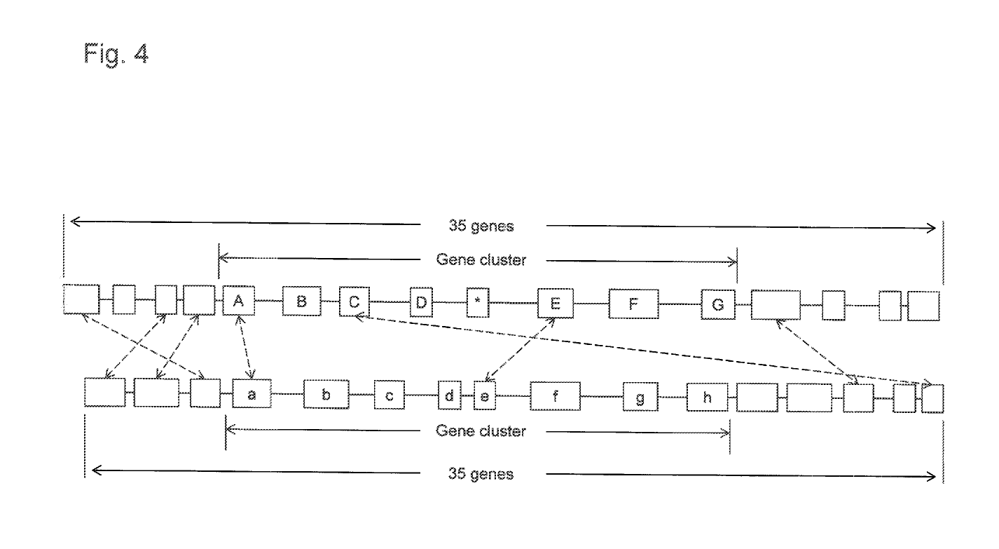

Subsequently, gene clusters satisfying the above conditions (e.g., Condition *2) are subjected to orthologue verification. Prior to orthologue verification, gene clusters are modified so as to adjust the number of genes included in each gene cluster to the total number of genes under the conditions described above (e.g., 35 genes under Condition *2) (FIG. 4). Specifically, genes in the vicinity of the gene cluster identified in the above process are added thereto so as to adjust the total number of genes to, for example, 35. For example, the same number of genes are added to both ends of the gene cluster identified in the above process, so that the gene cluster can be modified to comprise, for example, 35 genes in total. When an odd number of genes are to be added, the number of genes to be added to the 3′ end of the gene cluster may be increased or decreased by 1, although the manner of addition is not limited thereto. By adjusting the total number of genes to, for example, 35, an error at the boundary of the gene clusters identified in the above process can be taken into consideration, and the distribution of orthologous gene pairs in the vicinity can be averaged and evaluated. In FIG. 4, the number of genes is partly omitted for simplification.

With regard to xᵢ (i=1, 2, . . . , I) and yⱼ (j=1, 2, . . . J), the sets of the total genes when the number of genes included in a gene cluster is 35 are represented by X and Y, respectively.

X=(xᵢ|i is an integer satisfying a≦i≦b,provided that a≦i₁,iₙ≦b,b−a+1=35)

Y=(yⱼ|j is an integer satisfying c≦j≦d,provided that c≦j₁jₙ≦d,d−c+1=35)

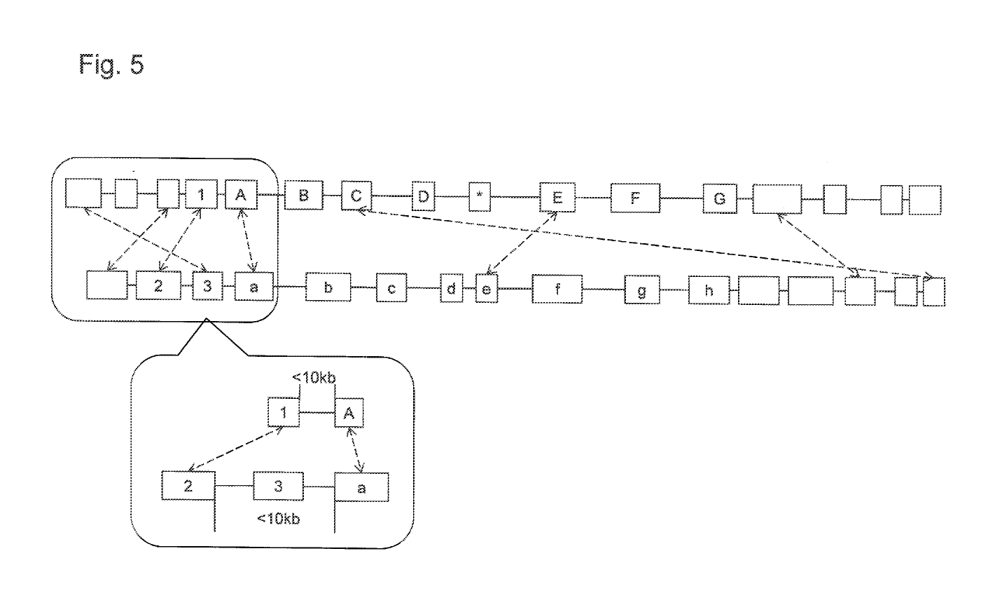

Whether or not combinations of orthologous genes between the genes included in X and Y are present is determined on the basis of the results of the homology search described above (dashed arrow in FIG. 4). When there are two or more combinations of orthologous genes between genes included in X and Y, synteny-like regions are identified. The term “synteny-like region” used herein refers to a region comprising a plurality of orthologous genes in which the distance between neighboring orthologous genes (other genes may be present therebetween) is not larger than the standard value. The standard value can be, for example, 10 to 30 kb, 10 to 20 kb, or 10 kb. For example, two pairs in the word balloons in FIG. 5; i.e., the pair of “A” and “a” and the pair of “1” and “2”, satisfy the conditions of the distance between “1” and “A” being less than 10 kb and that between “2” and “a” being less than 10 kb. Thus, the region between “1” and “A” and the region between “2” and “a” can be determined to be synteny-like regions. Whether or not all the combinations of orthologous genes included and in X and Y constitute synteny-like regions is inspected in the same manner. A plurality of synteny-like regions may occasionally be present.

The synteny-like regions identified in X and Y are represented as subsets of X and Y; xSB and ySB, respectively. When the number of elements in both subsets is not more than a given proportion relative to the number of elements in X and Y as a whole, respectively, it is determined that a gene cluster comprising xᵢ and a gene cluster comprising yⱼ to include secondary metabolism-related genes. A given proportion is not particularly limited, and it can be 30%, 25%, or 20%. When a given proportion is designated as 25% (Condition *3), for example, those satisfying the following conditions can be predicted to be gene clusters including secondary metabolism-related genes.

$${x}_{i} ( {i}_{1} \leq i \leq {i}_{n} ) , {y}_{j} ( {j}_{1} \leq j \leq {j}_{n} ) \\ \{ \begin{matrix}n ( xSB ) + n ( X ) \leq 0.25 \\ n ( ySB ) + n ( Y ) \leq 0.25\end{matrix} \qquad {}^{*} 3$$

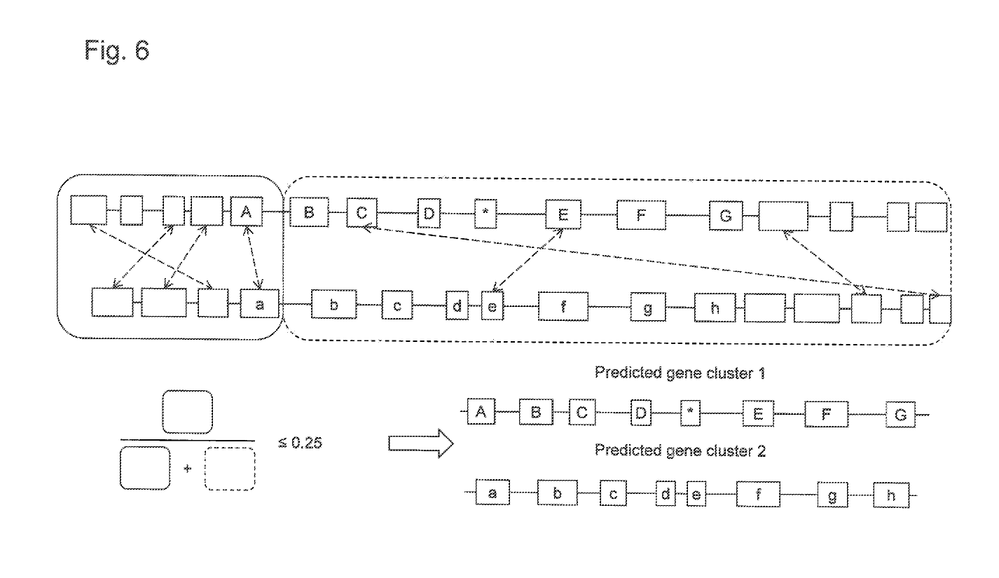

In FIG. 6, specifically, regions that were not determined to be synteny-like regions are framed with dashed lines. If the number of genes within the both synteny-like regions (within solid lines in FIG. 6) is 8 or less (i.e., less than 25% of the total number of genes: i.e., 35), initially identified regions from “A” to “C” and from “a” to “h” are predicted to be gene clusters including secondary metabolism-related genes, respectively.

A method for predicting a gene cluster including secondary metabolism-related genes is not limited to a method involving the use of the synteny-like region identified in accordance with the procedure described above. A synteny like region identified by another method may be used. An example of a method for identifying a synteny-like region is a method in which nucleotide sequence information of different types of genomes and annotation information are used to determine a synteny region and a non-synteny region in advance.

With the use of the synteny region determined in advance as the synteny-like region in the method of the present invention, a gene cluster including secondary metabolism-related genes can be predicted in the manner described above. That is, a method of identifying a synteny-like region on the basis of a synteny region can be carried out in the same manner as with the method of determining a synteny-like region described in FIG. 5. More specifically, orthologous genes are identified from among the genes predicted in the genomes from two species in advance, the synteny regions as defined above are identified, and regions other than the synteny region in nucleotide sequence information of the genomes are defined as non-synteny regions. Concerning the gene cluster represented by R₀ or gene clusters represented by R₀, R′₀, R″₀ . . . identified in the manner described above, cluster length is increased in accordance with the method described above (e.g., to a length of 35 genes). When the synteny regions (i.e., the synteny-like regions according to the method described above) account for less than 25% of the whole, the target can be predicted to be a gene cluster including secondary metabolism-related genes.

According to this method, a gene cluster including secondary metabolism-related genes can be occasionally predicted with higher accuracy than with the method comprising detecting a gene cluster and then identifying a synteny-like region described above. In the case of comparison between highly related species such as A. flavus and A. oryzae, for example, some A. oryzae strains may have a gene cluster highly homologous to the aflatoxin biosynthesis gene cluster. In addition, other A. flavus or A. oryzae strains do not have the second gene cluster highly homologous to the gene cluster described above. Accordingly, the aflatoxin biosynthesis gone cluster that is present in A. flavus may not be detected. In such a case, the third genome is used to determine a synteny region in advance for one of the two types of organism species to be actually compared. This can improve predictability. According to this method, a synteny region is defined as a gene region that is present in common in relatively related species, such as Aspergillus.

With a method for predicting a gene cluster including secondary metabolism-related genes, as described above, the gene clusters to be evaluated were limited on the basis of number of genes included in the gene clusters. According to the prediction method of the present invention, however, the gene clusters to be evaluated may be limited on the basis of gene cluster length. Specifically, gene cluster length may be compared with a given standard value, and a gene cluster with a length, less than the standard value may be subjected to orthologue verification. While the standard value is not particularly limited, it may be, for example, 125 kb (corresponding to about 50 genes), preferably 100 kb (corresponding to about 40 genes), and more preferably 87.5 kb (corresponding to about 35 genes).

According to a method for predicting a gene cluster including secondary metabolism-related genes, as described above, the number of genes included in a gene cluster was adjusted to a given level (e.g., 35) prior to orthologue verification. According to the prediction method of the present invention, however, a given number of genes or a region of a given length may be added to a gene cluster so as to modify the gene cluster prior to orthologue verification, and the modified gene cluster may then be subjected to orthologue verification.

A gene cluster can be modified by, for example, a method comprising modifying the gene cluster boundary, as described below. That is, the boundaries of particular gene clusters represented by R₀, R′₀, R″₀ . . . are modified. Modification of the gene cluster boundary is synonymous with determination as to the necessity of addition of genes located outside the gene cluster identified by the method described in the [Identification of gene cluster] section above to the gene cluster.

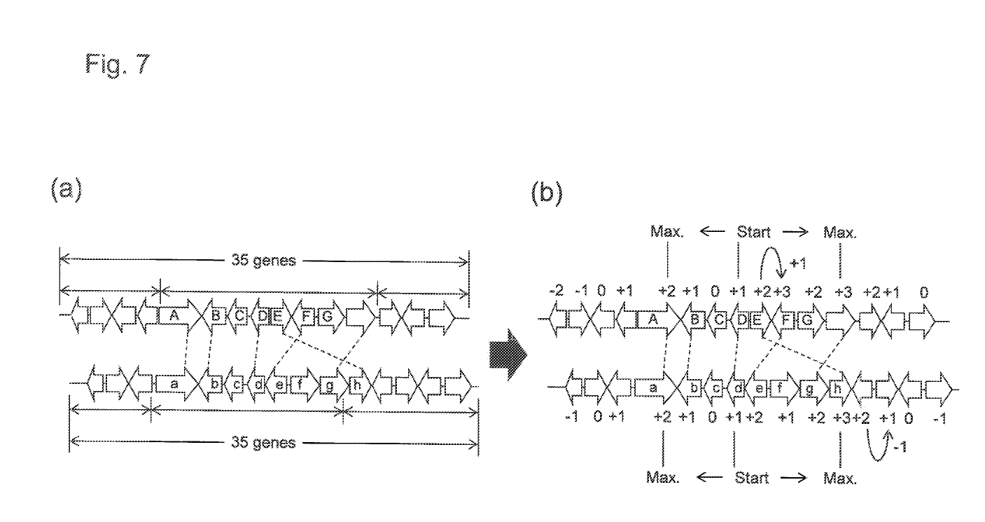

As shown in FIG. 7 (a), more specifically, the gene clusters represented by R₀, R′₀, R″₀ . . . are first elongated so as to adjust the number of genes included in the gene clusters to 15 to 65, and further specifically 35 (although the number of genes is not limited to 35), as described above. Regarding genes constituting the elongated gene clusters, subsequently, positive scores are given when there are highly homologous genes in the gene clusters to be compared, and negative scores are given when there are no highly homologous genes. As shown in FIG. 7(b), the scores assigned to the genes are successively summed from the gene located in the center of the elongated gene cluster toward both ends, and the total score is then assigned to each gene. Subsequently, the gene exhibiting the maximal total value of scores assigned to the genes included in the elongated gene cluster is identified, and the identified gene is determined to be the gene cluster boundary. The gene serving as the gene cluster boundary may not be modified, and the original gene cluster may occasionally remain as a result of the above procedure.

More specifically, the assemblies of the total genes when the number of genes included in the gene clusters, for example, xᵢ (i=1, 2, . . . , I) and yⱼ(1, 2, . . . , J), are designated as X and Y, respectively.

X=(xᵢ|i is an integer satisfying a≦i≦b,provided that a≦i₁,iₙ≦b,b−a+1=35)

Y=(yⱼ|j is an integer satisfying c≦j≦d,provided that c≦j₁jₙ≦d,d−c+1=35)

In order to modify the gene cluster boundary, the one-dimensional sequence (SC) comprising n(X) number of elements was prepared. The scores determined in accordance with, for example, the formulae shown below can be assigned to the elements of the sequence. When xᵢ is homologous to at least one of y_{c}, y_{c-1}, . . . y_{d-1}, and y_{d}:

$$SC ( i ) = \{ \begin{matrix}1 ( i = \frac{{i}_{1} + {i}_{n}}{2} ) \\ SC ( i + 1 ) + 1 ( i < \frac{{i}_{1} + {i}_{n}}{2} ) … ( 1 ) \\ SC ( i - 1 ) + 1 ( 1 > \frac{{i}_{1} + {i}_{n}}{2} ) … ( 2 )\end{matrix} \}$$

When xᵢ is not homologous to any of y_{c}, y_{c-1}, . . . , y_{d-1}, and y_{d}:

$$SC ( i ) = \{ \begin{matrix}+ negative ( i = \frac{{i}_{1} + {i}_{n}}{2} ) \\ SC ( i + 1 ) + negative ( i < \frac{{i}_{1} + {i}_{n}}{2} ) \\ SC ( i - 1 ) + negative ( i > \frac{{i}_{1} + {i}_{n}}{2} )\end{matrix} \}$$

After the scores were determined for all the elements in the sequence, the elements exhibiting the maximal scores within the relevant ranges (1) and (2) indicated above are designated as iₛₜₐᵣₜ su and iₛₜₒₚ, respectively. The set Y is subjected to the same procedure.

iₛₜₐᵣₜ and iₛₜₒₚ identified in the manner described above are designated as the gene cluster boundaries. Specifically, gene clusters with modified boundaries are represented as follows.

xᵢ(iₛₜₐᵣₜ≦i≦iₛₜₒₚ),yⱼ(jₛₜₐᵣₜ≦j≦jₛₜₒₚ)

In a score represented by SC(j) attained when xᵢ is homologous to none of y_{c}, y_{c-1}, . . . y_{d-1}, or y_{d}, a negative value can be, for example, −0.1, −0.2, −03, −0.4, −0.5, or −1.

By modifying the boundaries of the gene clusters represented by R₀, R′₀, R″₀ . . . in the manner described above, accuracy of prediction of the gene clusters including secondary metabolism-related genes through orthologue verification can be improved. Modification of the gene cluster boundary may be carried out before or after the process of orthologue verification described above.

### [Prediction Device and Prediction Program]

The method for predicting a gene cluster including secondary metabolism-related genes according to the present invention described above can be implemented with the use of a computer equipped with an input unit, such as a mouse and a keyboard, a central processing unit (CPU), a storage unit including volatile and/or non-volatile memory, and an output unit, such as a display. A computer is preferably connected to a memory unit such as an external database or an external computer system through a communication network such as the internet or an intranet. Specifically, the prediction method according to the present invention can be provided as a prediction program that can predict a gene cluster including secondary metabolism-related genes with the use of the computer unit constituted as described above. In other words, a computer in which such prediction program has been installed is a prediction device for a gene cluster including secondary metabolism-related genes.

In order to implement the prediction method using a computer, nucleotide sequence information of a pair of genome may be inputted into a computer from an external storage unit or a computer system through a communication network. Alternatively, the computer may be connected to a DNA sequencer through an interface, and sequence information may be inputted into the computer. In addition, storage media such as a DVD or a CD may be used to read nucleotide sequence information of a pair of genomes into the computer.

With the use of a computer, nucleotide sequence information of a pair of genomes can be subjected to homology search with the aid of a central processing unit, and the results of the homology search can be stored in the storage unit. With the use of a computer, in addition, the procedures for [Identification of gene clusters] and [Determination of gene cluster including secondary metabolism-related genes] described above can be performed with the use of software equipped with an algorithm that searches for strings of letters, such as the Smith-Waterman algorithm.

### EXAMPLES

Hereafter, the present invention is described in greater detail with reference to the following examples, although the technical scope of the present invention is not limited to such examples.

### Example 11

In Example 1, 8 types of genomic data sets were used. The data of Aspergillus oryzae equivalent to the data registered at GenBank (AP007150-AP007177) were used. The data of Aspergillus flavus downloaded from GenBank in the GenBank file format were used (GenBank Accession NOs: EQ963472 to EQ963493). The data of Aspergillus fumigatas, Aspergillus nidulans, Aspergillus terreus, Magnaporthe grisea, Fusarium graminearum, and Chaetomium globosum were downloaded from the Broad Institute.

In Example 1, genes exhibiting e-values of 1.0e-10 or less as a result of homology search were designated as homologous genes. In Example 1, also, a pair of genes was designated as a pair of orthologous genes when the genes were listed on the top in the list of the pairs of genes prepared in descending order (i.e., ascending order of e-value) as a result of homology search.

In Example 1, also, gene arrangement conservation was examined using the Smith-Waterman algorithm, and gene clusters represented by R₀, R′₀, R″₀ . . . were identified. In order to identify a synteny-like region, standards to the effect that the number of homologous gene combinations included in the identified gene cluster should be at least 3 and the total number of genes should be less than 35 were established in Example 1. In addition, the term “synteny-like region” used herein refers to a region comprising a plurality of orthologous genes in which the distance between neighboring orthologous genes (although other genes may be present therebetween) is 10 kb or less, 20 kb or less, or 30 kb or less.

In Example 1, the original gene cluster in which the number of genes included in the synteny-like region (subsets of X and Y: xSB and ySB) is less than 25% (i.e., 8 or fewer) of the 35 genes was predicted to be a gene cluster including secondary metabolism-related genes.

With the use of 10 genomic nucleotide sequences of filamentous fungi such as A. flavus or A. oryzae for which genomic analyses had been completed, the number of gene clusters including secondary metabolism-related genes was predicted by the method described above, and Table 1 shows the results of such prediction. Table 1-1 shows the results attained by defining a synteny-like region as a region in which the distance between neighboring orthologous genes is 10 kb or less. Table 12 shows the results attained by designating such distance as 20 kb or less, and Table 1-3 shows the results attained by designating such distance as 30 kb or less. These results demonstrate that the results would not significantly vary if the synteny-like region were to be defined as a region in which the distance between neighboring orthologous genes was 10 kb to 30 kb.

TABLE 1-1
distance_10 kb permissible percentage_25% elongation 35gene the number of gene clusters

| | database | | | | | | | | | |
|---|---|---|---|---|---|---|---|---|---|---|
| | A. | A. | A. | A. | A. | F. | F. | F. | C. | M. |
| query | flavus | oryzae | terreus | fumigatus | nidulans | graminearum | verticillioides | oxysporum | globosum | grisea |
| A. flavus | — | 102 | 107 | 75 | 101 | 83 | 95 | 101 | 37 | 46 |
| A. oryzae | 107 | — | 98 | 67 | 95 | 68 | 99 | 113 | 34 | 48 |
| A. terreus | 85 | 81 | — | 62 | 84 | 77 | 86 | 107 | 37 | 54 |
| A. fumigatus | 60 | 54 | 51 | — | 57 | 42 | 51 | 53 | 35 | 28 |
| A. nidulans | 96 | 82 | 90 | 68 | — | 72 | 80 | 86 | 41 | 49 |
| F. graminearum | 76 | 70 | 70 | 44 | 69 | — | 88 | 90 | 29 | 39 |
| F. verticillioides | 86 | 88 | 87 | 60 | 89 | 90 | — | 114 | 34 | 50 |
| F. oxysporum | 97 | 101 | 117 | 66 | 104 | 129 | 138 | — | 47 | 68 |
| C. globosum | 38 | 31 | 40 | 37 | 38 | 33 | 35 | 44 | — | 23 |
| M. grisea | 38 | 43 | 44 | 33 | 36 | 36 | 43 | 55 | 17 | — |

TABLE 1-2
distance_20 kb permissible percentage_25% elongation 35gene the number of gene clusters

| | database | | | | | | | | | |
|---|---|---|---|---|---|---|---|---|---|---|
| | A. | A. | A. | A. | A. | F. | F. | F. | C. | M. |
| query | flavus | oryzae | terreus | fumigatus | nidulans | graminearum | verticillioides | oxysporum | globosum | grisea |
| A. flavus | — | 102 | 104 | 72 | 100 | 78 | 89 | 92 | 32 | 42 |
| A. oryzae | 107 | — | 98 | 65 | 92 | 65 | 91 | 103 | 28 | 41 |
| A. terreus | 84 | 79 | — | 59 | 84 | 67 | 75 | 93 | 24 | 42 |
| A. fumigatus | 57 | 53 | 49 | — | 56 | 36 | 45 | 47 | 26 | 21 |
| A. nidulans | 94 | 79 | 88 | 68 | — | 65 | 73 | 74 | 35 | 43 |
| F. graminearum | 71 | 66 | 62 | 40 | 62 | — | 86 | 89 | 23 | 33 |
| F. verticillioides | 80 | 82 | 78 | 55 | 82 | 87 | — | 114 | 28 | 42 |
| F. oxysporum | 90 | 96 | 105 | 62 | 94 | 125 | 138 | — | 41 | 63 |
| C. globosum | 32 | 25 | 29 | 27 | 30 | 24 | 27 | 36 | — | 17 |
| M. grisea | 33 | 35 | 33 | 25 | 32 | 32 | 35 | 48 | 12 | — |

TABLE 1-3
distance_30 kb permissible percentage_25% elongation 35gene the number of gene clusters

| | database | | | | | | | | | |
|---|---|---|---|---|---|---|---|---|---|---|
| | A. | A. | A. | A. | A. | F. | F. | F. | C. | M. |
| query | flavus | oryzae | terreus | fumigatus | nidulans | graminearum | verticillioides | oxysporum | globosum | grisea |
| A. flavus | — | 102 | 104 | 71 | 100 | 78 | 89 | 92 | 31 | 42 |
| A. oryzae | 107 | — | 96 | 63 | 92 | 65 | 90 | 103 | 25 | 41 |
| A. terreus | 84 | 79 | — | 59 | 84 | 66 | 74 | 93 | 24 | 42 |
| A. fumigatus | 57 | 52 | 49 | — | 55 | 36 | 44 | 46 | 26 | 21 |
| A. nidulans | 93 | 79 | 88 | 67 | — | 63 | 72 | 73 | 34 | 42 |
| F. graminearum | 71 | 65 | 60 | 40 | 62 | — | 86 | 89 | 22 | 32 |
| F. verticillioides | 80 | 82 | 77 | 54 | 82 | 86 | — | 114 | 28 | 42 |
| F. oxysporum | 90 | 96 | 105 | 61 | 94 | 124 | 136 | — | 39 | 62 |
| C. globosum | 31 | 22 | 29 | 27 | 29 | 23 | 26 | 34 | — | 16 |
| M. grisea | 33 | 35 | 33 | 25 | 32 | 29 | 35 | 47 | 12 | — |

Table 2 shows the results of calculation of the proportion of gene clusters containing Q genes among the gene clusters predicted to include secondary metabolism-related genes in Example 1. The term “Q genes” refer to genes that are classified as secondary metabolism-related genes as a result of functional classification of clusters of orthologous groups (COG).

TABLE 2-1
distance_10 kb permissible percentage_25% elongation 35gene the ratio of gene clusters containing Qgene (%)

| | database | | | | | | | | | |
|---|---|---|---|---|---|---|---|---|---|---|
| | A. | A. | A. | A. | A. | F. | F. | F. | C. | M. |
| query | flavus | oryzae | terreus | fumigatus | nidulans | graminearum | verticillioides | oxysporum | globosum | grisea |
| A. flavus | — | 66.7 | 61.7 | 62.7 | 68.3 | 54.2 | 61.1 | 61.4 | 70.3 | 76.1 |
| A. oryzae | 64.5 | — | 57.1 | 59.7 | 60 | 57.4 | 69.7 | 64.6 | 64.7 | 66.7 |
| A. terreus | 65.9 | 64.2 | — | 86.1 | 67.9 | 55.8 | 55.8 | 51.4 | 56.8 | 57.4 |
| A. fumigatus | 60 | 55.6 | 56.9 | — | 56.1 | 47.6 | 54.9 | 60.4 | 57.1 | 57.1 |
| A. nidulans | 67.4 | 68.3 | 64.4 | 70.6 | — | 59.7 | 58.8 | 57 | 61 | 87.3 |
| F. graminearum | 61.8 | 64.3 | 57.1 | 65.9 | 56.5 | — | 50 | 52.2 | 65.5 | 43.6 |
| F. verticillioides | 60.5 | 61.4 | 55.2 | 60 | 50.6 | 40 | — | 51.8 | 41.2 | 56 |
| F. oxysporum | 62.9 | 59.4 | 53 | 54.5 | 52.9 | 48.1 | 51.4 | — | 29.8 | 54.4 |
| C. globosum | 68.4 | 58.1 | 45 | 40.5 | 55.3 | 57.6 | 37.1 | 34.1 | — | 43.5 |
| M. grisea | 68.4 | 69.8 | 50 | 60.6 | 66.7 | 52.8 | 58.1 | 56.4 | 52.9 | — |

TABLE 2-2
distance_20 kb permissible percentage_25% elongation 35gene the ratio of gene clusters containing Qgene (%)

| | database | | | | | | | | | |
|---|---|---|---|---|---|---|---|---|---|---|
| | A. | A. | A. | A. | A. | F. | F. | F. | C. | M. |
| query | flavus | oryzae | terreus | fumigatus | nidulans | graminearum | verticillioides | oxysporum | globosum | grisea |
| A. flavus | — | 66.7 | 62.5 | 65.3 | 69 | 55.1 | 61.8 | 64.1 | 68.8 | 76.2 |
| A. oryzae | 64.5 | — | 57.1 | 60 | 60.9 | 58.5 | 72.5 | 68 | 67.9 | 75.6 |
| A. terreus | 66.7 | 63.3 | — | 69.5 | 67.9 | 62.7 | 61.3 | 57 | 70.8 | 64.3 |
| A. fumigatus | 59.6 | 56.6 | 57.1 | — | 57.1 | 52.8 | 62.2 | 63.8 | 69.2 | 66.7 |
| A. nidulans | 67 | 68.4 | 64.8 | 70.6 | — | 66.2 | 63 | 64.9 | 68.6 | 76.7 |
| F. graminearum | 64.8 | 65.2 | 62.9 | 70 | 62.9 | — | 50 | 51.7 | 69.6 | 45.5 |
| F. verticillioides | 62.5 | 63.4 | 60.3 | 63.6 | 54.8 | 41.4 | — | 51.8 | 46.4 | 59.5 |
| F. oxysporum | 65.6 | 61.5 | 58.1 | 56.5 | 57.4 | 48 | 61.5 | — | 34.1 | 54 |
| C. globosum | 71.9 | 64 | 58.6 | 48.1 | 66.7 | 75 | 40.7 | 41.7 | — | 58.8 |
| M. grisea | 75.8 | 80 | 60.6 | 76 | 75 | 58.2 | 82.9 | 54.2 | 75 | — |

TABLE 2-3
distance_30 kb permissible percentage_25% elongation 35gene the ratio of gene clusters containing Qgene (%)

| | database | | | | | | | | | |
|---|---|---|---|---|---|---|---|---|---|---|
| | A. | A. | A. | A. | A. | F. | F. | F. | C. | M. |
| query | flavus | oryzae | terreus | fumigatus | nidulans | graminearum | verticillioides | oxysporum | globosum | grisea |
| A. flavus | — | 66.7 | 62.5 | 66.2 | 69 | 55.1 | 61.8 | 64.1 | 67.7 | 76.2 |
| A. oryzae | 64.5 | — | 58.3 | 61.9 | 60.9 | 58.5 | 73.3 | 68 | 72 | 75.6 |
| A. terreus | 66.7 | 63.3 | — | 69.5 | 67.9 | 83.6 | 62.2 | 57 | 70.8 | 64.3 |
| A. fumigatus | 59.6 | 57.7 | 57.1 | — | 56.4 | 52.8 | 61.4 | 63 | 69.2 | 66.7 |
| A. nidulans | 67.7 | 68.4 | 64.8 | 70.1 | — | 66.7 | 62.5 | 64.4 | 67.6 | 76.2 |
| F. graminearum | 64.8 | 64.6 | 63.3 | 70 | 62.9 | — | 48.8 | 51.7 | 72.7 | 46.9 |
| F. verticillioides | 62.5 | 63.4 | 61 | 63 | 54.9 | 40.7 | — | 51.8 | 46.4 | 50.5 |
| F. oxysporum | 65.6 | 61.5 | 58.1 | 55.7 | 57.4 | 48.4 | 51.5 | — | 35.9 | 54.8 |
| C. globosum | 71 | 68.2 | 58.6 | 48.1 | 65.5 | 78.3 | 42.3 | 41.2 | — | 62.5 |
| M. grisea | 75.8 | 80 | 60.6 | 76 | 75 | 58.6 | 62.9 | 53.2 | 75 | — |

The results shown in Table 2 demonstrate that gene clusters predicted to include secondary metabolism-related genes in Example 1 are highly likely to include Q genes. This indicates that a gene cluster including secondary metabolism-related genes can be predicted with high accuracy according to the method described in Example 1 and that a gene cluster including secondary metabolism-related genes, which could not be identified in accordance with a conventional methodology, is highly likely to be identified.

### Example 2

In Example 2, gene arrangement conservation was examined using the Smith-Waterman algorithm in the same manner as in Example 1, and gene clusters represented by R₀, R′₀, R″₀ . . . were identified. In Example 2, also, gene clusters including secondary metabolism-related genes were predicted in the same manner as in Example 1 except for the points described below. That is, in a process for modifying the boundary between the identified gene clusters, a score of “+1” was assigned for each gene included in the gene cluster, which had been elongated to contain 35 genes, in the presence of homologous genes, a score of “−0.3” was assigned in the absence of homologous genes, the scores were summed from the center of the elongated gene cluster, and the gene exhibiting the maximal total of the scores was designated as the gene cluster boundary.

A part of gene clusters including secondary metabolism-related genes predicted in Example 2 are shown in Table 3. As with the case of Example 1, Table 4 shows gene clusters including secondary metabolism-related genes, which were predicted without modification of the gene cluster boundary.

TABLE 3

| Gene cluster | | Error | | | | | | |
|---|---|---|---|---|---|---|---|---|
| Boundary | Boundary | Up- | Down- | Secondary | Cluster | | | Comparative |
| gene ID | geneID | stream | stream | metabolites | size | | Organism | organism |
| AFLA_139060 | AFLA_139460 | 9 | 2 | aflatoxin | 29 | genes | Aspergillus flavus | Magnaporthe grisea |
| AFLA_064360 | AFLA_064590 | −3 | −6 | gliotoxin | 33 | genes | Aspergillus flavus | Aspergillus fumigatus |
| AO090113000131 | AO090113000147 | 4 | 9 | kojic acid | 3 | genes | Aspergillus oryzae | Aspergillus flavus |
| ANID_01036 | ANID_01029 | 0 | 0 | asperfuranone | 8 | genes | Aspergillus nidulans | Aspergillus terreus |
| — | — | — | — | asperthecin | 3 | genes | Aspergillus nidulans | — |
| ANID_02625 | ANID_02624 | 0 | −3 | penicillin | 6 | genes | Aspergillus nidulans | Aspergillus terreus |
| ANID_07805 | ANID_07825 | −1 | 0 | sterigmato- | 25 | genes | Aspergillus nidulans | Magnaporthe grisea |
| | | | | cystin | | | | |
| ANID_08517 | ANID_08524 | 4 | 5 | terrequinone | 7 | genes | Aspergillus nidulans | Fusarium graminearum |
| Afu2g17960 | Afu2g18040 | 0 | −2 | ergot | 11 | genes | Aspergillus fumigatus | Aspergillus terreus |
| Afu3g12890 | Afu3g12960 | 0 | 0 | ETP^{c} | 8 | genes | Aspergillus fumigatus | Aspergillus nidulans |
| Afu8g00170 | Afu8g00260 | 0 | 0 | fumitremorgin | 10 | genes | Aspergillus fumigatus | Aspergillus oryzae |
| Afu6g09610 | Afu6g09740 | 2 | 0 | gliotoxin | 12 | genes | Aspergillus fumigatus | Fusarium oxysporum |
| Afu2g17490 | Afu2g17610 | 4 | 1 | melanin | 8 | genes | Aspergillus fumigatus | Fusarium graminearum |
| — | — | — | — | Pes1 | 2 | genes | Aspergillus fumigatus | — |
| Afu8g00450 | Afu8g00580 | 8 | 0 | pseurotin | 6 | genes | Aspergillus fumigatus | Fusarium verticillioides |
| Afu3g03350 | Afu3g03480 | 0 | 1 | siderophore | 13 | genes | Aspergillus fumigatus | Fusarium graminearum |
| ATEG_09957 | ATEG_09977 | 1 | 3 | lovastatin | 17 | genes | Aspergillus terreus | Aspergillus oryzae |
| FGSG_02322 | FGSG_02330 | −2 | 0 | aurofusarin | 11 | genes | Fusarium graminearum | Aspergillus terreus |
| FGSG_02392 | FGSG_02400 | 5 | 2 | zearalenone | 5 | genes | Fusarium graminearum | Chaetomium globosum |
| FVEG_03384 | FVEG_03379 | 0 | 0 | bikaverin | 6 | genes | Fusarium verticillioides | Chaetomium globosum |
| FVEG_00329 | FVEG_00316 | 0 | −2 | fumonisin | 16 | genes | Fusarium verticillioides | Aspergillus fumigatus |
| — | — | — | — | fusaric acid | 5 | genes | Fusarium verticillioides | — |
| FVEG_11079 | FVEG_11086 | −1 | 0 | fusarin C | 9 | genes | Fusarium verticillioides | Magnaporthe grisea |
| FVEG_03698 | FVEG_03695 | −2 | 0 | perithecium | 6 | genes | Fusarium verticillioides | Aspergillus flavus |
| | | | | pigment | | | | |

TABLE 4

| Gene cluster | | Error | | | | | | |
|---|---|---|---|---|---|---|---|---|
| Boundary | Boundary | Up- | Down- | Secondary | Cluster | | | Comparative |
| gene ID | gene ID | stream | stream | metabolites | size | | Organism | organism |
| AFLA_139090 | AFLA_139540 | 6 | 10 | aflatoxin | 29 | genes | Aspergillus flavus | Magnaporthe grisea |
| AFLA_064360 | AFLA_064590 | −3 | −6 | gliotoxin | 33 | genes | Aspergillus flavus | Aspergillus fumigatus |
| AO090113000131 | AO090113000144 | 4 | 6 | kojic acid | 3 | genes | Aspergillus oryzae | Aspergillus flavus |
| ANID_01036 | ANID_01029 | 0 | 0 | asperfuranone | 8 | genes | Aspergillus nidulans | Aspergillus terreus |
| — | — | — | — | asperthecin | 3 | genes | Aspergillus nidulans | — |
| ANID_02625 | ANID_02624 | 0 | −3 | penicillin | 6 | genes | Aspergillus nidulans | Aspergillus terreus |
| ANID_07804 | ANID_07825 | 0 | 0 | sterigmato- | 25 | genes | Aspergillus nidulans | Aspergillus terreus |
| | | | | cystin | | | | |
| ANID_08517 | ANID_08524 | −4 | 5 | terrequinone | 7 | genes | Aspergillus nidulans | Fusarium graminearum |
| Afu2g17960 | Afu2g18000 | 0 | −6 | ergot | 11 | genes | Aspergillus fumigatus | Aspergillus terreus |
| Afu3g12890 | Afu3g12960 | 0 | 0 | ETP^{c} | 8 | genes | Aspergillus fumigatus | Aspergillus nidulans |
| Afu8g00170 | Afu8g00260 | 0 | 0 | fumitremorgin | 10 | genes | Aspergillus fumigatus | Aspergillus oryzae |
| Afu6g09610 | Afu6g09760 | 2 | 2 | gliotoxin | 12 | genes | Aspergillus fumigatus | Fusarium graminearum |
| Afu2g17490 | Afu2g17660 | 4 | 6 | melanin | 8 | genes | Aspergillus fumigatus | Fusarium graminearum |
| — | — | — | — | Pes1 | 2 | genes | Aspergillus fumigatus | — |
| Afu8g00490 | Afu8g00580 | 4 | 0 | pseurotin | 6 | genes | Aspergillus fumigatus | Fusarium verticillioides |
| Afu3g03350 | Afu3g03450 | 0 | −2 | siderophore | 13 | genes | Aspergillus fumigatus | Fusarium graminearum |
| ATEG_09960 | ATEG_09973 | −2 | −1 | lovastatin | 17 | genes | Aspergillus terreus | Magnaporthe grisea |
| FGSG_02322 | FGSG_02330 | −2 | 0 | aurofusarin | 11 | genes | Fusarium graminearum | Aspergillus terreus |
| FGSG_02392 | FGSG_02400 | 5 | 2 | zearalenone | 5 | genes | Fusarium graminearum | Chaetomium globosum |
| FVEG_03384 | FVEG_03379 | 0 | 0 | bikaverin | 6 | genes | Fusarium verticillioides | Chaetomium globosum |
| FVEG_00325 | FVEG_00316 | −4 | −2 | fumonisin | 16 | genes | Fusarium verticillioides | Aspergillus fumigatus |
| — | — | — | — | fusaric acid | 5 | genes | Fusarium verticillioides | — |
| FVEG_11079 | FVEG_11086 | −1 | 0 | fusarin C | 9 | genes | Fusarium verticillioides | Magnaporthe grisea |
| FVEG_03698 | FVEG_03695 | −2 | 0 | perithecium | 6 | genes | Fusarium verticillioides | Aspergillus flavus |
| | | | | pigment | | | | |

In Table 3 and Table 4, the column indicating “Error” represents the number of genes in the predicted gene cluster that are out of alignment toward the upstream direction (toward the 5′ end) and toward the downstream direction (toward the 3′ end) relative to the gene cluster that actually includes secondary metabolism-related genes.

As is apparent from Table 4, 94 genes were counted as errors when the gene cluster boundary was not modified. This indicates that each of the 21 gene clusters shown in Table 4 includes 4.5 errors on average. When the gene cluster boundary was modified, in contrast 82 genes were counted as errors, and each of the 21 gene clusters includes 3.9 errors on average. Thus, by modifying the gene cluster boundary, a gene cluster including secondary metabolism-related genes can be detected with higher accuracy.

All publications, patents, and patent applications cited herein are incorporated herein by reference in their entirety.

1. A method for predicting a gene cluster including secondary metabolism-related genes comprising:
a step of subjecting genes included in nucleotide sequence information of at least a pair of genomes to homology search mutually to identify homologous gene combinations in the nucleotide sequence information of the genomes and orthologous gene combinations in the homologous gene combinations;
a step of identifying a region of the gene arrangement of which is conserved in the nucleotide sequence information of other genomes as a gene cluster on the basis of the results of homology search; and
a step of identifying a synteny-like region in the gene cluster identified in the previous step on the basis of the presence of orthologous genes determined as a result of homology search and evaluating whether or not the gene cluster includes secondary metabolism-related genes on the basis of the rate of the synteny-like region in the gene cluster.

2. The method of prediction according to claim 1, wherein the gene cluster is evaluated to include secondary metabolism-related genes when the rate of the genes included in the synteny-like region relative to the genes included in the whole gene cluster is not more than a given level.

3. The method of prediction according to claim 2, wherein the given level is 25%.

4. The method of prediction according to claim 1, wherein the synteny-like region includes at least two orthologous genes and the distance between neighboring orthologous genes is within a given distance in the nucleotide sequence information of genomes and in the nucleotide sequence inform on of the other genomes.

5. The method of prediction according to claim 4, wherein the given distance is 10 kb to 30 kb.

6. The method of prediction according to claim 1, wherein a synteny region and a non-synteny region are determined in advance using nucleotide sequence information of one of at least a pair of genomes subjected to comparison and nucleotide sequence information of a third genome that is different from the pair of genomes and the determined synteny region is designated as a synteny-like region.

7. The method of prediction according to claim 1, wherein the step of gene cluster identification is followed by a step in which the number of homologous genes included in the identified gene cluster and/or the total number of genes included in the identified gene cluster are compared with the predetermined standard values and the step of evaluating whether or not the gene cluster includes secondary metabolism-related genes is carried out with regard to the gene cluster exhibiting the number of homologous genes not less than the standard value and/or the gene cluster exhibiting the total number of genes less than the standard value.

8. The method of prediction according to claim 7, wherein the standard value for the number of homologous genes is designated 3 and the standard value for the total number of genes is designated 35.

9. The method of prediction according to claim 1, wherein the step of gene cluster identification is followed by a step in which the total number of genes included in the identified gene cluster is compared with the predetermined standard value or a length of the identified gene cluster is compared with the predetermined standard value and the step of evaluating whether or not the gene cluster includes secondary metabolism-related genes is carried out with regard to the gene cluster exhibiting the total number of genes or the length less than the standard value,
wherein, in the step of evaluating whether or not the gene cluster includes secondary metabolism-related genes, genes neighboring the gene cluster to be evaluated are added to modify the gene cluster to comprise the number of genes defined as the standard value and a synteny-like region in the modified gene cluster consisting of the number of genes defined as the standard value is identified.

10. The method of prediction according to claim 9, wherein the standard value for the total number of genes is designated 35.

11. The method of prediction according to claim 1, wherein the step of gene cluster identification is followed by a step in which the total number of genes included in the identified gene cluster is compared with the predetermined standard value or a length of the identified gene cluster is compared with the predetermined standard value and the step of evaluating whether or not the gene cluster includes secondary metabolism-related genes is carried out with regard to the gene cluster exhibiting the total number of genes or the length less than the standard value,
wherein, in the step of evaluating whether or not the gene cluster includes secondary metabolism-related genes, a given number of genes or a given length of a region is added to modify the gene cluster to be evaluated and a synteny-like region in the modified gene cluster is identified.

12. The method of prediction according to claim 1, wherein the step of gene cluster identification comprises starting the trace backing from a cell exhibiting the maximal score in the Smith-Waterman matrix built on the basis of the Smith-Waterman algorithm so as to identify a gene cluster.

13. The method of prediction according to claim 12, wherein the step of gene cluster identification comprises assigning a score of 0 into a cell included in the identified gene cluster, subjecting the Smith-Waterman matrix to the trace backing so as to identify another region in which the gene arrangement is conserved, subjecting the identified region to the Smith-Waterman algorithm again so as to identify a region the gene arrangement of which is conserved, and identifying the region as a gene cluster.

14. The method of prediction according to claim 1, wherein the step of gene cluster identification is followed by a step in which the total number of genes included in the identified gene cluster is compared with the predetermined standard value or a length of the identified gene cluster is compared with the predetermined standard value and a given number of genes or a given length of a region is added to the gene cluster so as to elongate the gene cluster to the standard size,
positive scores are given to the genes constituting the elongated gene cluster that are homologous to the genes constituting the gene cluster in the nucleotide sequence information of the other genomes to be compared, and negative scores are given to the genes that are not homologous,
scores are successively totaled from the gene located at the center of the gene cluster toward the ends and the genes exhibiting the maximal total scores are identified as the gene cluster boundaries, and
a region between the genes identified as the boundaries is identified as a gene cluster.

15. The method of prediction according to claim 14, wherein the predetermined standard value for the total number of genes is designated 15 to 65.

16. A program for predicting a gene cluster including secondary metabolism-related genes that allows a computer equipped with an input unit, a central processing unit, and a storage unit to execute:
a step in which the central processing unit is allowed to execute homology search of genes included in nucleotide sequence information of at least a pair of genomes mutually to identify homologous gene combinations in the nucleotide sequence information of genomes and orthologous gene combinations in the homologous gene combinations;
a step in which the central processing unit is allowed to identify a region of the gene arrangement of which is conserved in the nucleotide sequence information of other genomes on the basis of the results of homology search as a gene cluster; and
a step in which the central processing unit is allowed to identify a synteny-like region in the gene cluster identified in the above step on the basis of the presence of orthologous genes and evaluate whether or not the gene cluster includes secondary metabolism-related genes on the basis of the rate of the synteny-like region in the gene cluster.

17. The prediction program according to claim 16, wherein the central processing unit is allowed to determine that the gene cluster includes secondary metabolism-related genes when the rate of the genes included in the synteny-like region relative to the genes included in the whole gene cluster is not more than a given level.

18. The prediction program according to claim 17, wherein the given level is 25%.

19. The prediction program according to claim 16, wherein the synteny-like region includes at least two orthologous genes and the distance between neighboring orthologous genes is within a given distance in the nucleotide sequence information of genomes and in the nucleotide sequence information of the other genomes.

20. The prediction program according to claim 19, wherein the given distance is 10 kb to 30 kb.

21. The prediction program according to claim 16, wherein a synteny region and a non-synteny region are determined in advance using nucleotide sequence information of one of at least a pair of genomes subjected to comparison and nucleotide sequence information of a third genome that is different from the pair of genomes and the determined synteny region is designated as a synteny-like region.

22. The prediction program according to claim 16, wherein the step of gene cluster identification is followed by a step in which the central processing unit is allowed to compare the number of homologous genes included in the identified gene cluster and/or the total number of genes included in the identified gene cluster with the predetermined standard values and carry out the step of evaluating whether or not the gene cluster includes secondary metabolism-related genes with regard to the gene cluster exhibiting the number of homologous genes not less than the standard value and/or the gene cluster exhibiting the total number of genes less than the standard value.

23. The prediction program according to claim 22, wherein the standard value for the number of homologous genes is designated 3 and the standard value for the total number of genes is designated 35.

24. The prediction program according to claim 16, wherein the step of gene cluster identification is followed by a step in which the central processing unit is allowed to compare the total number of genes included in the identified gene cluster with the predetermined standard value or compare a length of the identified gene cluster with the predetermined standard value and carry out the step of evaluating whether or not the gene cluster includes secondary metabolism-related genes with regard to the gene cluster exhibiting the total number of genes or the length less than the standard value,
wherein, in the step of evaluating whether or not the gene cluster includes secondary metabolism-related genes, genes neighboring the gene cluster to be evaluated are added to modify the gene cluster to comprise the number of genes defined as the standard value ad a synteny-like region in the modified gene cluster consisting of the number of genes defined as the standard value is identified.

25. The prediction program according to claim 24, wherein the standard value for the total number of genes is designated 35.

26. The prediction program according to claim 16, wherein the step of gene cluster identification is followed by a step in which the central processing unit is allowed to compare the total number of genes included in the identified gene cluster with the predetermined standard value or compare a length of the identified gene cluster with the predetermined standard value and carry out the step of evaluating whether or not the gene cluster includes secondary metabolism-related genes with regard to the gene cluster exhibiting the total number of genes or the length less than the standard value,
wherein, in the step of evaluating whether or not the gene cluster includes secondary metabolism-related genes, a given number of genes or a given length of a region is added to modify the gene cluster to be evaluated and a synteny-like region in the modified gene cluster is identified.

27. The prediction program according to claim 16, wherein the step of gene cluster identification comprises starting the trace backing from a cell exhibiting the maximal score in the Smith-Waterman matrix built on the basis of the Smith-Waterman algorithm so as to identify a gene cluster.

28. The prediction program according to claim 27, wherein the step of gene cluster identification comprises assigning a score of 0 into a cell included in the identified gene cluster, subjecting the Smith-Waterman matrix to the trace backing so as to identify another region in which the gene arrangement is conserved, subjecting the identified region to the Smith-Waterman algorithm so as to identify a region in which the gene arrangement is conserved, and identifying the region as a gene cluster.

29. The prediction, program according to claim 16, wherein the step of gene cluster identification is followed by a step in which the central processing unit is allowed to compare the total number of genes included in the identified gene cluster with the predetermined standard value or compare a length of the identified gene cluster with the predetermined standard value and a given number of genes or a given length of a region is added to the gene cluster so as to elongate the gene cluster to the standard size,
positive scores are given to the genes constituting the elongated gene cluster that are homologous to the genes constituting the gene cluster in the nucleotide sequence information of the other genomes to be compared, and negative scores are given to the genes that are not homologous,
scores are successively totaled from the gene located at the center of the gene cluster toward the ends and the genes exhibiting the maxima total scores are identified as the gene cluster boundaries, and
a region between the genes identified as the boundaries is identified as a gene cluster.

30. The prediction program according to claim 29, wherein the predetermined standard value for the total number of genes is designated 15 to 65.

31. A prediction device for a gene cluster including secondary metabolism-related genes equipped with an input unit, a central processing unit, and a storage unit,
the device comprising:
a means for homology search by which the central processing unit is allowed to execute homology search of genes included in nucleotide sequence information of at least a pair of genomes mutually to identify homologous gene combinations in the nucleotide sequence information of genomes and orthologous gene combinations in the homologous gene combinations;
a means for gene cluster identification by which the central processing unit is allowed to identify a region of the gene arrangement of which is conserved in the nucleotide sequence information of other genomes on the basis of the results of homology search as a gene cluster; and
a means for evaluation by which the central processing unit is allowed to identify a synteny-like region in the gene cluster identified by the means for gene cluster identification on the basis of the presence of orthologous genes found as a result of the homology search and evaluate whether or not the gene cluster includes secondary metabolism-related genes on the basis of the rate of the synteny-like region in the gene cluster.

32. The prediction device according to claim 31, wherein the central processing unit is allowed to determine that the gene cluster includes secondary metabolism-related genes when the rate of the genes included in the synteny-like region relative to the genes included in the whole gene cluster is not more than a given level.

33. The prediction device according to claim 32, wherein the given level is 25%.

34. The prediction device according to claim 31, wherein the synteny-like region includes at least two orthologous genes and the distance between neighboring orthologous genes is within a given distance in the nucleotide sequence information of genomes and in the nucleotide sequence information of the other genomes.

35. The prediction device according to claim 34, wherein the given distance is 10 kb to 30 kb.

36. The prediction device according to claim 31, wherein a synteny region and a non-synteny region are determined in advance using nucleotide sequence information of one of at least a pair of genomes subjected to comparison and nucleotide sequence information of a third genome that is different from the pair of genomes and the determined synteny region is designated as a synteny-like region.

37. The prediction device according to claim 31, wherein the process of the means for gene cluster identification is followed by a process in which the central processing unit is allowed to compare the number of homologous genes included in the identified gene cluster and/or the total number of genes included in the identified gene cluster with the predetermined standard values and the process by the means for evaluation whether or not the gene cluster includes secondary metabolism-related genes is carried out with regard to the gene cluster exhibiting the number of homologous genes not less than the standard value and/or the gene cluster exhibiting the total number of genes less than the standard value.

38. The prediction device according to claim 37, wherein the standard value for the number of homologous genes is designated 3 and the standard value for the total number of genes is designated 35.

39. The prediction device according to claim 31, wherein the process of the means for gene cluster identification is followed by a process in which the central processing unit is allowed to compare the total number of genes included in the identified gene cluster with the predetermined standard value or a length of the identified gene cluster with the predetermined standard value and the process by the means for evaluation whether or not the gene cluster includes secondary metabolism-related genes is carried out with regard to the gene cluster exhibiting the total number of genes or the length less than the standard values,
wherein the means for evaluation whether or not the gene cluster includes secondary metabolism-related genes add genes neighboring the gene cluster to be evaluated to modify the gene cluster to comprise the number of genes defined as the standard value and identify a synteny-like region in the modified gene cluster consisting of the number of genes defined as the standard value.

40. The prediction device according to claim 39, wherein the standard value for the total number of genes is designated 35.

41. The prediction device according to claim 31, wherein the process of the means for gene cluster identification is followed by a process in which the central processing unit is allowed to compare the total number of genes included in the identified gene cluster with the predetermined standard value or a length of the identified gene cluster with the predetermined standard value and the process by the means for evaluation whether or not the gene cluster includes secondary metabolism-related genes is carried out with regard to the gene cluster exhibiting the total number of genes or the length less than the standard values,
wherein the min for evaluation whether or not the gene cluster includes secondary metabolism-related genes add a given number of genes or a given length of a region to modify the gene cluster to be evaluated and identify a synteny-like region in the modified gene cluster.

42. The prediction device according to claim 31, wherein the means for gene cluster identification starts the trace backing from a cell exhibiting the maximal score in the Smith-Waterman matrix built on the basis of the Smith-Waterman algorithm so as to identify a gene cluster.

43. The prediction device according to claim 42, wherein the means for gene cluster identification assigns a score of 0 into a cell included in the identified gene cluster, subjects the Smith-Waterman matrix to the trace backing so as to identify another region in which the gene arrangement is conserved, subjects the identified region to the Smith-Waterman algorithm again so as to identify a region the gene arrangement of which is conserved, and identifies the region as a gene cluster.

44. The prediction device according to claim 31, wherein the process of the means for the gene cluster identification is followed by a process in which the central processing unit is allowed to compare the total number of genes included in the identified gene cluster with the predetermined standard value or compare a length of the identified gene cluster with the predetermined standard value and add a given number of genes or a region of a given length to the gene cluster so as to elongate the gene cluster to the standard size,
positive scores are given to the genes constituting the elongated gene cluster that are homologous to the genes constituting the gene cluster in the nucleotide sequence information of the other genomes to be compared, and negative scores are given to the genes that are not homologous,
scores are successively totaled from the gene located at the center of the gene cluster toward the ends and the genes exhibiting the maximal total scores are identified as the gene cluster boundaries, and
a region between genes identified as the boundaries is identified as a gene cluster.

45. The prediction device according to claim 44, wherein the predetermined standard value for the total number of genes is designated 15 to 65.
